(19) United States
(12) Patent Application Publication
(10) Pub. No.: US 2016/0224456 A1
(43) Pub. Date: Aug. 4, 2016

(54) METHOD FOR VERIFYING GENERATED SOFTWARE, AND VERIFYING DEVICE FOR CARRYING OUT SUCH A METHOD

(71) Applicant: FTS COMPUTERTECHNIK GMBH, Wien (AT)

(72) Inventor: Carsten WEICH, Wien (AT)

(21) Appl. No.: 15/021,275

(22) PCT Filed: Sep. 5, 2014
(86) PCT No.: PCT/AT2014/050197

§ 371 Date: Mar. 11, 2016

(30) Foreign Application Priority Data
Sep. 13, 2013 (AT) A50580/2013

(51) Int. Cl. G06F 11/36

(52) U.S. Cl. CPC G06F 11/3616; G06F 11/3692

(57) ABSTRACT

The invention relates to a method for verifying generated software (1), in particular of a computer program, which software (1) is produced by means of a software generator (2), wherein the software (1) is produced by the software generator (2) on the basis of a system description (3). The invention also relates to a verifying device for carrying out such a method. In order to verify the software (1) a verifying device (4) is provided, wherein

a) the system description (3) is read into the verifying device (4),
b) the verifying device (4) creates one or more software code patterns (5) on the basis of the system description (3),
c) the source text of the generated software (1) is read into the verifying device (4), and
d) the verifying device (4) checks the source text (1) for the presence of all software code patterns (5).

The invention relates to a method for verifying generated software, in particular of a computer program, which software is produced by means of a software generator, and/or for verifying a generated code, which is produced by means of a code generator, wherein the software and the code are created by the software generator and the code generator respectively on the basis of a system description.

ISO 26262 is an ISO standard for safety-relevant electrical/electronic systems in motor vehicles and has quickly become established since its introduction in 2011 as an important guideline for the development of control units for motor vehicles. ISO 26262 stipulates the rules in accordance with which safety-relevant hardware and software must be developed.

New software developments, in particular for control units for motor vehicles, are usually made in accordance with the AUTOSAR (automotive open system architecture) standard. In order to meet the standardisation requirements of AUTOSAR and the safety requirements of ISO 26262, basic software can be used, which has been developed in accordance with ISO 26262. A challenge that previously remained, however, was the AUTOSAR runtime environment (RTE). The AUTOSAR is used in an AUTOSAR-based vehicle control unit in order to exchange information between software components. When the control unit performs safety-relevant tasks, it must be ensured that the RTE cannot cause any faults.

### Safety Goal for the RTE

In order to answer the question of what it means for an RTE to “function correctly or safely”, the following assumptions are made:
The RTE is used on a safety-relevant ECU (“engine control unit”) with ASIL classification.
Information exchanged internally via the RTE between the software components of this ECU is safety-relevant.

The RTE thus “inherits” the ASIL of the functions accessing it.

Here, the following guarantees are understood to constitute the safety goal (IS026262 Safety Goal) of “safe data transfer”: RTE messages are written by a transmission component and can be read by previously defined receivers, and:
The receivers read the data as previously written.
RTE messages are transferred consistently, i.e. all associated individual signals together).
RTE messages are visible only for the previously defined receivers.
Optionally, previously defined runnables can be activated as soon as an RTE message is written.
Otherwise, the data transfer has no further effects.

RTE messages are collections of individual signals that belong together.

The RTE is usually a generated software of which the freedom from errors can only be detected with difficulty. In order to detect the freedom from errors, a number of possibilities exist in principle:
Use of a qualified generator for the software, in the case of an RTE use of an RTE generator, which produces an “error-free software” or an “error-free RTE”.
Checking/review of the generated code, in particular RTE code.
Tests.

The development of error-free generators, in particular RTE generators, appears unrealistic: due to the high complexity of such tools, a development in accordance with ISO would be very costly. Although the costs are only borne once, there is still the problem that a “certified generator” requires such a long time for development thereof that it hardly still corresponds to the current AUTOSAR version by the time it is completed. This approach is thus costly and also very inflexible.

Tests and manual reviews of the generated RTE code are currently the only possibilities. They are difficult to perform and are accordingly complex. In order to achieve the necessary test coverage, an RTE integration tester must firstly analyse in the generated code the automatically applied buffer variables, the generated data types and access macros, and must then provide corresponding tests.

One object is to provide an improved possibility for verifying generated software, i.e. for examining the software for freedom from errors.

A further object of the invention is to provide an improved possibility for verifying generated software for control units for motor vehicles.

These objects are achieved with a method of the type mentioned in the introduction in that, in accordance with the invention, a verifying device is provided for verifying the software or the code, wherein

a) the system description is read into the verifying device,
b) the verifying device creates one or more software code patterns or code patterns on the basis of the system description,
c) the source text of the generated software or of the generated code is read into the verifying device, and
d) the verifying device checks the source text or the code for the presence of all software code patterns or code patterns.

In accordance with the invention a static analysis is thus performed, i.e. the software or computer program to be verified is not running during the verification. In the case of this analysis the conditions and where applicable items that must be contained in the generated code are determined by the verifying device on the basis of the system description, which describes the software, and this “knowledge” is directly examined in the generated code by the verifying device. For this purpose, syntactic software code patterns are produced which should or must be present in the software code, and the code is then examined for the presence of all of these software code patterns. Here, “items” are elements/constituents, such as ports, tasks, components, etc., which are defined in the system description as parts of the system.

If all software code patterns are present free from errors, the generated software is also free from errors.

In accordance with one embodiment of the invention the system description is given in the form of an abstract system model. By way of example, in the event that the software is an RTE, in particular an AUTOSAR RTE for a control unit of a motor vehicle, the system description may be an (AUTOSAR) ECU configuration, which ECU configuration contains an/the AUTOSAR system description together with an/the AUTOSAR ECU description.

The system description may comprise at least one set of properties and/or at least one set of items which describe the software to be produced.

Here, in accordance with a specific embodiment of the invention, in step b) the verifying device generates, on the basis of the system description, all conditions for creating the at least one code pattern, which conditions describe the context for which the generated software has been produced. The context applies to the target system in which the generated software runs, not to the generation. In conjunction with an AUTOSAR RTE, such conditions may be, for example inter alia: “memory protection is used”, “multiple instantiation is possible”, “all code is available as source code”.

Furthermore, the verifying device, on the basis of the produced conditions, selects one or more code models, which are permissible for software production in the presence of the produced conditions, from a quantity of predefined code models.

The quantity of predefined code models is typically stored in a database associated with the verifying device.

In a next step the selected code models are then instantiated by the verifying device, i.e. variables present in the selected code models are replaced by values or information determined by the verifying device from the system description.

The verifying device now searches the source text of the generated software for the code patterns thus created and, if all (correct) code patterns are positively discovered, the verification is positive, i.e. the generated software is free from errors.

Furthermore, the verifying device comprises at least one verifying software or consists of a verifying software. The verifying device is usually an independent software, also referred to hereinafter as a verifying tool.

The invention can be used expediently when the generated software is a runtime environment.

The invention is particularly advantageous when the generated software is a software to be executed on a unit, for example on a control unit.

Is also favourable furthermore when the system description includes information relating to the unit for which the generated software is intended.

By way of example, a control unit contains different ports. The information relating to the (control) unit contained in the system description and to be taken into consideration in the event of generation of the software then contains, for example, the names, number and definition of the ports. These are taken into consideration in the event of generation of the software. Furthermore, the control unit may offer services. Here, “services” are functions that are requested by a user of the RTE and are activated by the software (RTE). Information relating to these services is preferably likewise contained in the system description.

On the other hand, this information is also involved in the generation of the software code patterns, and the software code patterns are created by the verifying means from the conditions and this information (name, number, definition of the ports).

Furthermore, in the case of a software in the form of a runtime environment, in particular a runtime environment for a control unit, which control unit is preferably intended for a motor vehicle, the system description advantageously at least contains:
names, number and definition of ports and/or
services in the control unit.

Here, in accordance with one specific embodiment, the system description is an ECU configuration, in particular an AUTOSAR ECU configuration, which ECU configuration contains a system description, in particular an AUTOSAR system description, together with an ECU description, in particular an AUTOSAR ECU description.

The verification device preferably checks whether all software code patterns are present in the source text, wherein the verifying device creates an output report, wherein the output report contains the marked source text, in which the generated software code patterns are marked.

In this context, what is known as a “coloured source code” can be produced, i.e. a listing of the generated code in which all found code patterns (patterns) are marked, for example in colour, for example in green. This marked code can then be easily checked “manually” by a user in order to ascertain whether all code parts are marked accordingly (in colour). All code parts which, for the verifying device, correspond with known code patterns are marked accordingly, i.e. are coloured in this case.

If code parts remain that are not marked, then either the software generator has made a mistake or the user has used an unsupported software feature, in particular an unsupported Autosar RTE feature. In particular in the safety-relevant software components, the Autosar RTE user should use only a limited functional scope (the Autosar RTE-verify safety manual describes which functions are supported). If, in addition, further functions are used, these remain uncoloured in the coloured source code and must be checked manually—in the conventional manner by test and review.

Is also advantageous when the verifying device checks whether all software code patterns are present in the source text, wherein the verifying device generates an error report listing all software code patterns not found in the source text by the verifying device.

Alternatively, the verifying device produces a report in which code patterns are listed which were expected by the verifying device and discovered.

The verification is successful when the marked source code contains no unmarked areas and when the error report is empty or when the expected and discovered code patterns match.

In particular, it is lastly also advantageous when the verifying device outputs a consideration feedback report containing all information and/or conditions determined by the verifying device from the system description that is/are relevant to the generation of the software.

The system description used for generation of the software is provided from what is known as the system design, from which the system description is produced by means of a corresponding design tool, for example the “DaVinci Developer” tool.

In the configuration feedback report a subset of the system design is presented, which is used as input for the generation of the software. The user can therefore easily check on the basis of this configuration feedback report whether the used system description is the same (at least in respect of the information relevant for the generation) as that evident from the configuration feedback report.

In the case of an end-to-end testing by the user, errors in the generation chain of the software can thus be ruled out, specifically in particular whether
the generator and the verifying device have operated with incorrect input;
the input was empty, which would lead to a trivial “empty” error.

Furthermore, the objects mentioned in the introduction are also achieved with a verifying device, in particular a verifying software for carrying out an above-described method.

The invention also relates to a software, in particular a computer program, for example control software, for a motor vehicle, wherein the software is verified in accordance with a method as described above.

It is advantageous when the software is based on an AUTOSAR standard.

It is advantageous when the software is provided in the form of a runtime environment.

It is advantageous when a system description of the runtime environment at least contains:
names, number and definition of ports and/or
services in the control unit.

It is advantageous when the system description is an ECU configuration, in particular an AUTOSAR ECU configuration, which ECU configuration contains a system description, in particular an AUTOSAR system description together with an ECU description, in particular an AUTOSAR ECU description.

Lastly, the invention also relates to a control unit for a motor vehicle, on which at least one above-described software or at least one above-described computer program runs.

The invention will be explained in greater detail hereinafter on the basis of a non-limiting example illustrated in the drawing, in which

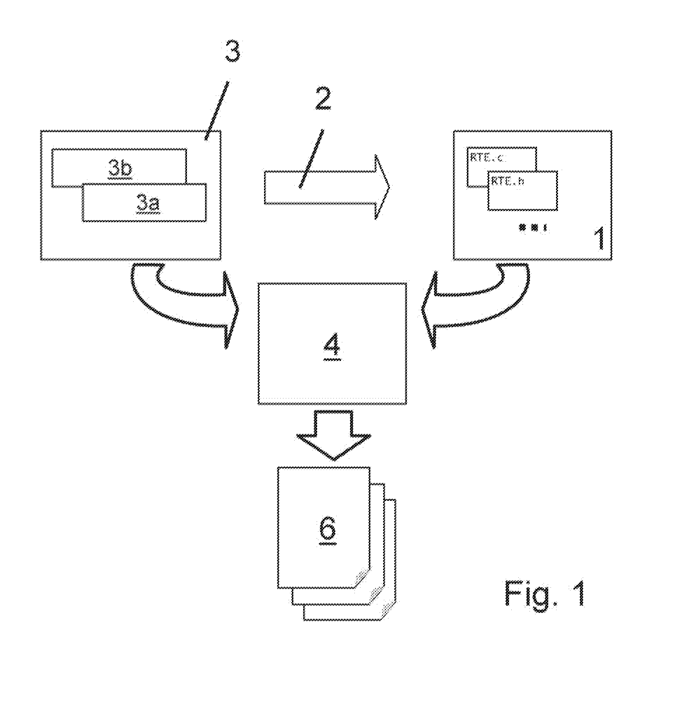

FIG. 1 schematically shows the generation of an RTE,

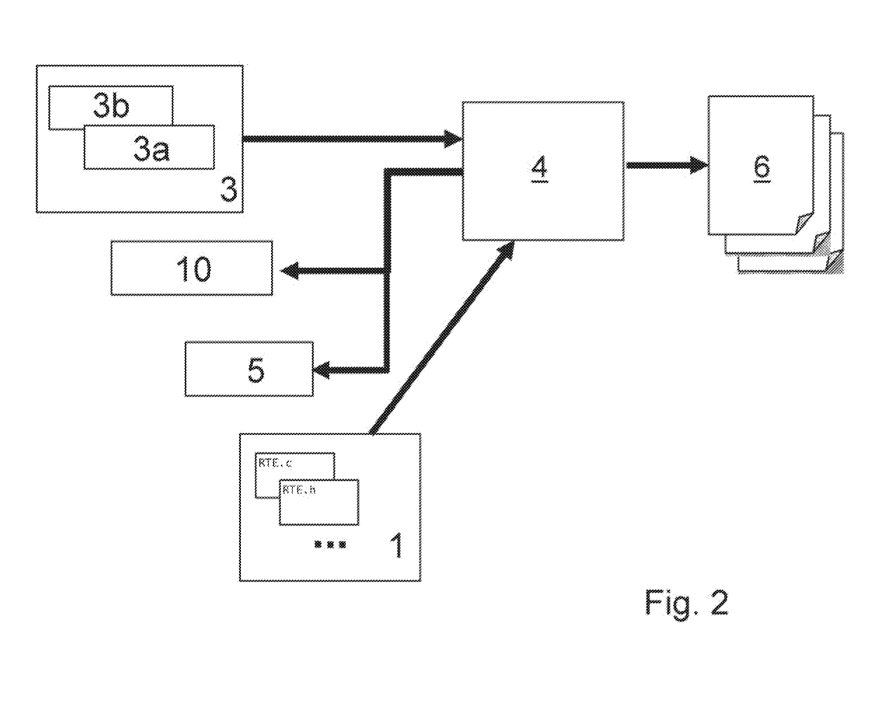

FIG. 2 schematically shows the course of a verifying process according to the invention,

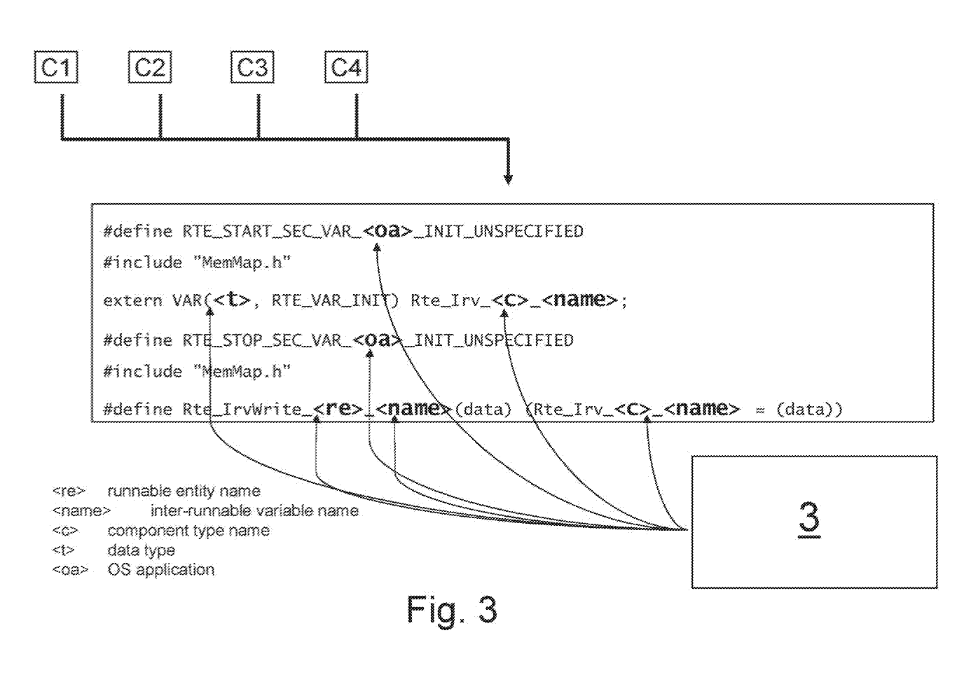

FIG. 3 shows a schematic illustration of a code model used by a verifying device for production of a software code pattern, and

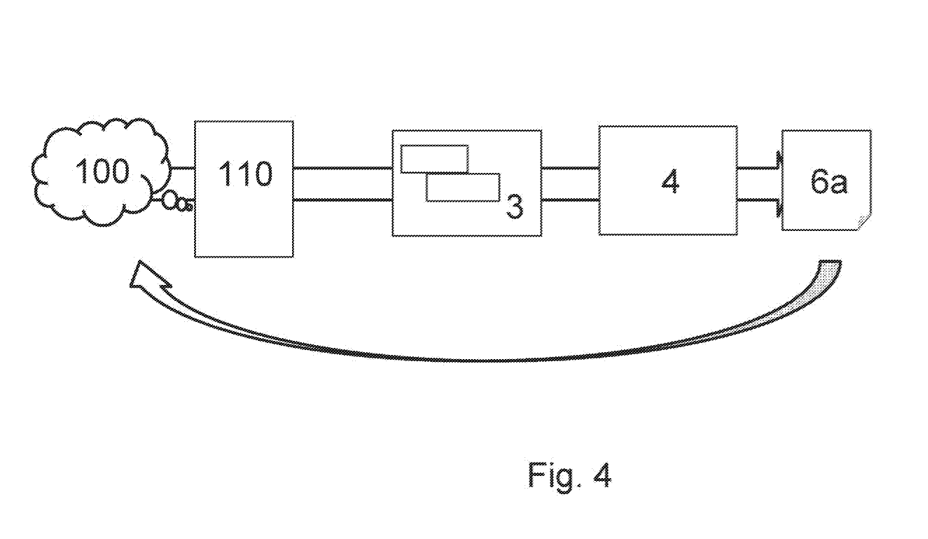

FIG. 4 shows an end-to-end safeguarding of the software generation process.

FIG. 1 schematically shows the process of generation of a software 1. This software 1 may in principle be any software, and in the presented example is an AUTOSAR RTE, also referred to hereinafter as an RTE. The presented verifying method is particularly advantageous for an RTE of this type.

The software (RTE) 1 is produced, as shown in FIG. 1, using a software generator 2, wherein the software 1 is created by the software generator 2 on the basis of a system description 3.

The system description 3 may be given here in the form of an abstract system model, and/or the system description 3 comprises one or more sets of properties and/or one or more sets of commands, which describe the software to be produced.

In the case of an AUTOSAR RTE for a control unit of a motor vehicle, the system description 3 is present in the form of an (AUTOSAR) ECU configuration, which contains an AUTOSAR system description 3b together with an AUTOSAR ECU description 3a.

By way of example, the system description 3 contains tasks, ports and services in the control unit for which the RTE is intended. If two software components for example exchange messages via the RTE, corresponding “ports” must then be declared in the system description. This system description is read in by the RTE generator 2. So that the message exchange functions reliably, the RTE generator 2 must produce a code 1, in which the buffers required for the message exchange are correctly arranged and the access functions to these buffers are correctly defined. The buffers must be large enough, and the access functions must observe the buffer size and cannot be interruptible, etc.

FIG. 1 also schematically shows the verifying process according to the invention. As can be seen in the figure, a verifying device 4 in the form of a verifying software (also referred to hereinafter as a “verifying tool”) is provided in order to verify the software 1. The system description 3 is read into the verifying device 4, and the verifying device 4 creates one or more software code patterns 5 (see FIG. 3) on the basis of the read-in system description 3, the source text of the generated software 1 is read into the verifying device 4, and the verifying device 4 checks the source text 1 for the presence of all software code patterns 5 produced thereby.

Lastly, one or more reports 6 is/are output, which will be discussed in greater detail further below.

FIG. 2 again shows the verifying process in a detailed illustration. As can be seen in FIG. 2, all conditions 10, which conditions 10 describe the context for which the generated software has been produced, are firstly produced by the verifying device 4 on the basis of the system description 3 in order to create the at least one code pattern 5. The context applies to the target system in which the generated software runs, not to the generation.

Furthermore, the verifying device 4, on the basis of the produced conditions 10, then selects one or more code models, which are permissible for software production in the presence of the produced conditions 10, from a quantity of predefined code models. The quantity of predefined code models are typically stored in a database associated with the verifying device 4.

In particular in the case of safety-critical applications (safety), a number of code models are available, which are carefully tested/checked/verified and are qualified for a use for generation of a safety-relevant software. Such code models are available to the verifying device.

The verifying device 4 then selects, from the available code models, the relevant code models which in the context described by the software description are relevant for the production of the software.

In a next step the selected code models are then instantiated by the verifying device 4, i.e. variables present in the selected code models are replaced by values determined by the verifying device 4 from the system description 3.

The code patterns 5 are produced in this way from the code models. Here, the same code model may also be used a number of times with different configuration of the variables.

In order to explain the situation once more on the basis of a specific example of an AUTOSAR RTE: by way of example two components each having one port are described in the system description. One port of one component serves as an output port, and the port of the other component serves as an input port. These ports are connected in the system description. The verifying device reads this system description and therefore “knows” that there are two components and connected ports. For each component and for each port, the following must therefore be provided in the generated RTE code parts:
a code to construct the port;
a code to send output data;
a code to read input data, etc.
   the verifying device creates a list of code parts (code patterns), which it must provide in the code. The templates (code models) with variables for port names, component names, names of the types of data to be exchanged, etc. are provided from the database. These names are likewise read from the system description and replaced in the templates (“templates are instantiated”). The verifying tool thus has the code parts in the form in which they must be present in the actual generated RTE code. The presence of these parts in the generated code is checked. If they are present in precisely this form, the generated RTE is considered to be verified.

By way of example, if there is a control unit-internal communication path the following is true: if there is one port, it must be defined both on the transmitter side and on the receiver side, it must provide buffer variables in order to transfer the information, and lastly it must provide macros with which these buffers are described or read during transmission and reception. All of these conditions are translated into C language patterns, and these patterns are then detected in the generated code.

An example of a code model from which a code pattern 5 (not shown in FIG. 3) is created is illustrated in FIG. 3. The conditions 10 (C1, C2, C3, C4, C5) which make the shown code model valid are to be met in the code model in accordance with the system description or ECU configuration. The variables <re> (runnable entity name), <oa> (OS application), <t> (data type), <c> (component type name) and <name> (inter-runnable variable name) are replaced with corresponding values in accordance with the system description.

As already explained, the verifying device 4 checks whether all such software code patterns 5 are present in the source text 1 of the software. The verifying device 4 creates an output report 6 (see FIGS. 1 and 2), wherein the output report 6 contains the marked source text, in which the produced software code patterns 5 are marked.

In this context, what is known as a “coloured source code” can be produced, i.e. a listing of the generated code in which all found code patterns (patterns) are marked, for example in colour, for example in green. This marked code can then be easily checked “manually” by a user in order to ascertain whether all code parts are marked accordingly (in colour). All code parts which, for the verifying device, correspond with known code patterns are marked accordingly, i.e. are coloured in this case.

If code parts remain that are not marked, then either the software generator has made a mistake or the user has used an unsupported software feature, in particular an unsupported Autosar RTE feature. In particular in safety-relevant software components, the Autosar RTE user should use only a limited functional scope (the Autosar RTE-verify safety manual describes which functions are supported). If, in addition, further functions are used, these remain uncoloured in the coloured source code and must be checked manually—in the conventional manner by test and review.

It is also advantageous when the verifying device 4 checks whether all software code patterns 5 are present in the source text, wherein the verifying device 4 generates an error report 6 listing all software code patterns not found in the source text by the verifying device 4. Alternatively, the verifying device 4 produces a report 6 in which code patterns are listed which were expected by the verifying device 4 and found.

The verification is successful when the marked source code contains no unmarked areas and when the error report is empty or when the expected and discovered code patterns match.

In particular, it is lastly also advantageous when the verifying device 4 as shown in FIG. 4 outputs a configuration feedback report 6a containing all information and/or conditions determined by the verifying device 4 from the system description 3 that is/are relevant to the generation of the software.

The system description 3 used for generation of the software 1 is provided from what is known as the system design 100. The system description 3 is produced from the system design 100 by means of a suitable design tool 110, for example the “DaVinci Developer” tool.

In the configuration feedback report 6a a subset of the system design 100 is presented, which is used as input for the generation of the software 1. The user can therefore easily check on the basis of this configuration feedback report 6a whether the used system description is the same (at least in respect of the information relevant for the generation) as that evident from the configuration feedback report 6a.

In the case of an end-to-end testing by the user, errors in the generation chain of the software 1 can thus be ruled out, specifically in particular whether
the generator and the verifying device have operated with incorrect input;
the input was empty, which would lead to a trivial “empty” error.

In an ISO 26262-based project, the development tools must also be qualified. The configuration feedback 6a shows whether the correct system description has been used. Since the RTE verifying tool 4 (RTE verify) again displays the ECU configuration 3 used for the verification, the entire chain of the RTE configuration tool is safeguarded (FIG. 4). When an integrator checks the configuration feedback, it also receives a confirmation for the RTE design tool and different further processing steps in the run-up to the verification.

The integrator receives, by the RTE verifying tool 4, a confirmation that the RTE generation process is based on the correct configuration data and that it has been run through without errors. The observance of the safety manual, in which the permissible RTE functionality has been restricted for safety-relevant functions, is thus also reconfirmed.

From the viewpoint of a safety auditor, the value of the RTE verifying tool 4 lies in the fact that the code parts used by the RTE are separated, attributed to precisely defined preconditions, and therefore a review in accordance with ISO 26262 rules can be made accessible. Instead of having to check a complex code generator, which is constructed on a multiplicity of libraries and is associated with further complex tools, only short code fragments (code patterns (patterns)) must be checked in respect of the set safety goals. For a realistic functional scope, a few hundred patterns are typically necessary here. It can be demonstrated with a reasonable outlay and plausibly that all these patterns are checked carefully in accordance with checklists.

Only carefully checked patterns are carried over into the test scope of RTE verify 4. The test report of RTE verify thus delivers the confirmation that in a specific project only previously checked code parts have been used, i.e. the RTE consists of trustworthy codes—in accordance with the rules of ISO 26262.

The presented method according to the invention is extremely flexible. If, for example, AUTOSAR is developed further and certain functions are extended or modified, only the patterns in question must be adapted and re-checked.

The presented method according to the invention is fully transparent for the user, and the checking of the verification itself is simple. The method according to the invention drastically reduces the size of the code that has to be checked manually.

Other examples where the method according to the invention can be used relate generally to the verification of generated codes, for example configuration tables and generated codes for checksum calculations.

1. A method for verifying generated software computer program, which software is produced by means of a software generator, and/or for verifying a generated code, which is produced by means of a code generator, wherein the software and the code are created by the software generator and the code generator respectively on the basis of a system description, the method comprising:
providing a verifying device for verifying the software and/or the code, wherein
a) the system description is read into the verifying device,
b) the verifying device creates one or more software code patterns -or code patterns on the basis of the system description,
c) the source text of the generated software or of the generated code is read into the verifying device, and
d) the verifying device checks the source text or the code for the presence of all software code patterns or code patterns.

2. The method according to claim 1, wherein the system description is provided in the form of an abstract system model.

3. The method according to claim 1, wherein the system description comprises at least one set of properties and/or at least one set of commands, which describe the software to be produced.

4. The method according to claim 1, Wherein in step b) the verifying device generates, on the basis of the system description, all conditions for creating the at least one code pattern, which conditions describe the context for which the generated software has been produced.

5. The method according to claim 4, wherein the verifying device, on the basis of the produced conditions, selects one or more code models, which are permissible for software production in the presence of the produced conditions, from a quantity of predefined code models.

6. The method according to claim 5, wherein the quantity of predefined code models is stored in a database associated with the verifying device.

7. The method according to claim 6, wherein the selected code models are instantiated by the verifying device, such that variables present in the selected code models are replaced by values or information determined by the verifying device from the system description.

8. The method according to one of claim 1, wherein the verifying device comprises at least one verifying software or consists of a verifying software.

9. The method according to claim 1, wherein the generated software is a runtime environment.

10. The method according to claim 1, Wherein the generated software is a software to be executed on a control unit.

11. The method according to claim 10, wherein the control unit is a control unit for a motor vehicle.

12. The method according to claim 10, wherein the system description contains information relating to the control unit for which the generated software intended.

13. The method according to claim 12, wherein, in the case of a software in the form of a runtime environment for a control unit, which control unit is intended for a motor vehicle, the system description at least contains:
names, number and definition of ports and/or
services in the control unit.

14. The method according to claim 11, wherein the system description contains an engine control unit (ECU), configuration, which ECU configuration contains a system description, together with an ECU description.

15. The method according to claim 1, wherein the verifying device checks whether all software code patterns are present in the source text, wherein the verifying device creates an output report, wherein the output report contains the marked source text, in which the produced software code patterns are marked.

16. The method according to claim 1, wherein the verifying device checks whether all software code patterns are present in the source text, wherein the verifying device produces an error report listing all software code patterns not found in the source text by the verifying device.

17. The method according to claim 1, wherein the verifying device outputs a configuration feedback report, which contains all information and/or conditions determined by the verifying device from the system description that is/are relevant to the generation of the software.

18. A verifying device, verifying software for carrying out a method according to claim 1.

19. A software computer program, for a motor vehicle, wherein the software is verified in accordance with a method according to claim 1.

20. The software according to claim 19, wherein it is based on an AUTOSAR Standard.

21. The software according to claims 20, wherein it is provided in the form of a runtime environment.

22. The software according to claim 21, wherein a system description of the runtime environment at least contains:
names, number and definition of ports and/or
services in the control unit.

23. The software according to claim 22, the system description is an engine control unit (ECU) configuration, which ECU configuration contains a system description, together with an ECU description.

24. A control unit for a motor vehicle, on which at least one software or at least one computer program according to claim 19 runs.
